(19) United States
(12) Patent Application Publication
(10) Pub. No.: US 2010/0304248 A1
(43) Pub. Date: Dec. 2, 2010

(54) MOBILE TERMINAL AND METHOD FOR CONFIRMING REMAINING CAPACITY OF FUEL CELL

(76) Inventors: Susumu Takatsuka, Tokyo (JP); Tetsuya Naruse, Kanagawa (JP); Shin Takanashi, Kanagawa (JP)

Correspondence Address: FROMMER LAWRENCE & HAUG LLP, 745 FIFTH AVENUE, NEW YORK, NY, 10151, US

(21) Appl. No.: 12/786,578

(22) Filed: May 25, 2010

(30) Foreign Application Priority Data
Jun. 1, 2009 (JP) P2009-132486

(51) Int. Cl. H01M 8/04; G01N 27/416

(52) U.S. Cl. 429/428; 324/427

(57) ABSTRACT

A mobile terminal includes a fuel accommodation section that accommodates a fuel within a body, at least one face of the fuel accommodation section being formed by a transparent or translucent member, a fuel cell section that generates electricity on the basis of the fuel accommodated in the fuel accommodation section, a body orientation detection section that detects an orientation of the body, a storage section that stores scale display information concerning a plurality of orientations of the fuel accommodation section, a display section disposed on the face of the fuel accommodation section formed by the transparent or translucent member, and a control section that obtains the scale display information corresponding to the orientation detected by the body orientation detection section from the scale display information stored in the storage section, and displays the obtained scale display information on the display section.

### BACKGROUND OF THE INVENTION

1. Field of the Invention

The present invention relates to a mobile terminal suitably applied as a mobile phone terminal using a fuel cell as a power supply, and a method for confirming a remaining capacity of a fuel cell used for the mobile terminal.

2. Description of the Related Art

As a rechargeable battery used in a mobile terminal such as a mobile phone terminal, a fuel cell has been proposed. The fuel cell obtains electric power by generating electricity using hydrogen and so on as a fuel. In addition to a type in which pure hydrogen is directly used as the fuel, various types of fuel cells have been proposed, such as a type in which gasoline made from crude oil, liquefied petroleum gas, natural gas, or methanol is used as the fuel. Those fuels are reformed to generate reformed hydrogen, and the electricity is generated using the reformed hydrogen.

As for the electric power consumption time and the fuel cell output voltage of the fuel cell, even if the amount of the fuel decreases, the outputted voltage is maintained almost constant. The output voltage drops when the fuel becomes empty. Additionally, the output voltage does not depend on the supplied fuel pressure, but is constant. In other words, in a case of the fuel cell applied in the electric-powered units such as electronic devices, it is difficult to detect the remaining amount of fuel by monitoring the battery voltage, because the output voltage remains almost unchanged while the amount of fuel decreases. That is, discharge properties of the fuel cell are greatly different from those of the lithium-ion rechargeable battery or nickel-metal hydride rechargeable battery, and even if the remaining amount of the fuel decreases, the output voltage remains almost unchanged, whereby it is difficult to employ a remaining capacity detection system that utilizes battery voltage monitoring.

To deal with the situation above, in the past, various remaining capacity detection methods other than the voltage monitoring have been proposed as the remaining capacity detection system for the fuel cell.

For example, Japanese Unexamined Patent Application Publication No. 2006-228333 discloses a technique to store data that indicate a relationship between the amount of the fuel used and the amount of current generated by the fuel cell in association with the operational states and operational environments of the fuel reforming unit or the fuel cell. Then, on the basis of the data, the remaining capacity of the fuel cell is calculated, and the calculated capacity is indicated by percentage or time displayed on a display.

Japanese Unexamined Patent Application Publication No. 2005-197125 discloses a fuel cell having a fuel accommodation section that accommodates a fuel, a reaction section that performs power generation reaction using the fuel, a drainage storing section that stores water, which is a by-product as a result of the power generation reaction, in which at least part of the drainage storing section is formed using a transparent member.

### SUMMARY OF THE INVENTION

However, with the technique that displays the remaining capacity of the cell as described above, the remaining capacity is displayed only on the basis of the data calculated in advance indicating the relationship between the fuel cell and the amount of current, and hence, the correct remaining capacity of the cell may not be displayed. For example, if the amount of fuel replenished is not correctly obtained, the calculation result is deviated from the data indicating the relationship above, and the actual amount of fuel may not accord with the displayed amount. Furthermore, to display the remaining capacity of the cell, a dedicated display is necessary or an area for displaying the remaining capacity is necessary in a portion of the display.

It is desirable to accurately notify an operator of the remaining capacity of the fuel cell in the terminal that employs the fuel cell as the power supply.

According to an embodiment of the present invention, an orientation of a body that forms a terminal is detected, scale display information concerning a plurality of orientations is stored, the scale display information corresponding to the detected orientation is obtained from the stored scale display information, and a scale based on the obtained scale display information is displayed on a transparent or translucent face which is one of faces of a housing of a fuel accommodation section that accommodates the fuel.

With the configuration above, the scale indicating the remaining capacity of the fuel cell is displayed on a display section of the terminal at an appropriate orientation corresponding to an orientation of the terminal at that moment. The scale is displayed on the transparent or translucent face of the housing of the fuel accommodation section, whereby the remaining amount of the fuel can be reliably determined by checking the scale.

According to the embodiment of the present invention, the remaining capacity of the fuel cell can be accurately detected by visually recognizing the housing of the fuel accommodation section without providing an additional detection section to confirm the remaining capacity of the fuel cell accommodated in the fuel accommodation section.

### BRIEF DESCRIPTION OF THE DRAWINGS

FIG. 1A is a perspective view showing a mobile phone terminal according to an embodiment of the present invention, and FIG. 1B is a sectional view taken along the IB-IB line in FIG. 1A;

FIG. 2A is a perspective view when a numeric keypad, an input confirmation screen and a signal intensity status icon are displayed on a display section of the mobile phone terminal according to the embodiment of the present invention, and FIG. 2B is a sectional view taken along the IIB-IIB line in FIG. 2A;

FIG. 3 is a block diagram showing an internal configuration according to the embodiment of the present invention;

FIGS. 4A to 4C are perspective views each showing a screen example in which a scale indicating a remaining amount of fuel-cell fuel is displayed on the mobile phone terminal according to the embodiment of the present invention, where FIG. 4A is a perspective view when the mobile phone terminal is in an upright position, FIG. 4B is a perspective view when the mobile phone terminal is in a horizontal position, and FIG. 4C is a perspective view when the mobile phone terminal is tilted in a tilted position;

FIG. 5 is a flowchart illustrating an example of a process of displaying a scale according to the embodiment of the present invention;

FIG. 6A is a perspective view of a mobile phone terminal of a modified example according to the embodiment of the present invention, and FIG. 6B is a sectional view taken along the VIB-VIB line in FIG. 6A; and,

FIGS. 7A to 7C are perspective views each showing a screen example in which the scale indicating the remaining capacity of the fuel cell is displayed as the remaining time to be used on the mobile phone terminal according to the embodiment of the present invention, where FIG. 7A is a perspective view when the mobile phone terminal is in an upright position, FIG. 7B is a perspective view when the mobile phone terminal is in a horizontal position, and FIG. 7C is a perspective view when the mobile phone terminal is tilted in a tilted position.

### DESCRIPTION OF THE PREFERRED EMBODIMENTS

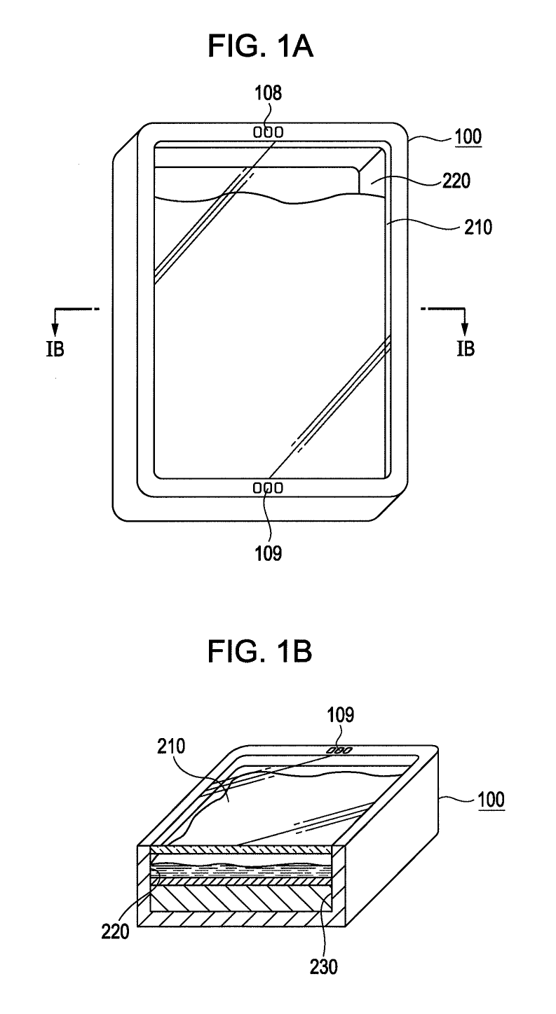

Hereinbelow, an embodiment of the present invention will be described in the following order with reference to FIGS. 1A to 5.

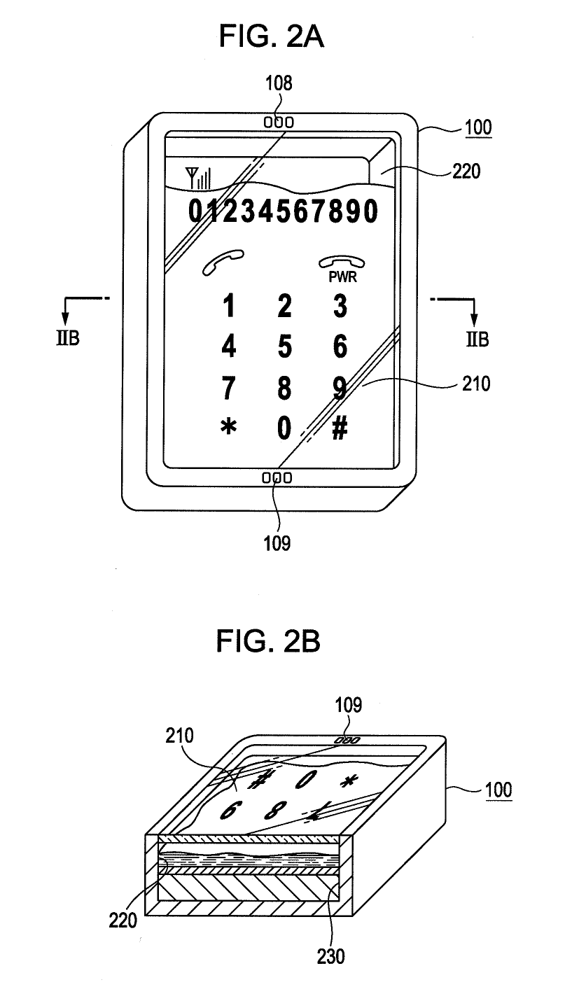

1. Outer shape of a terminal (FIGS. 1A to 2B)

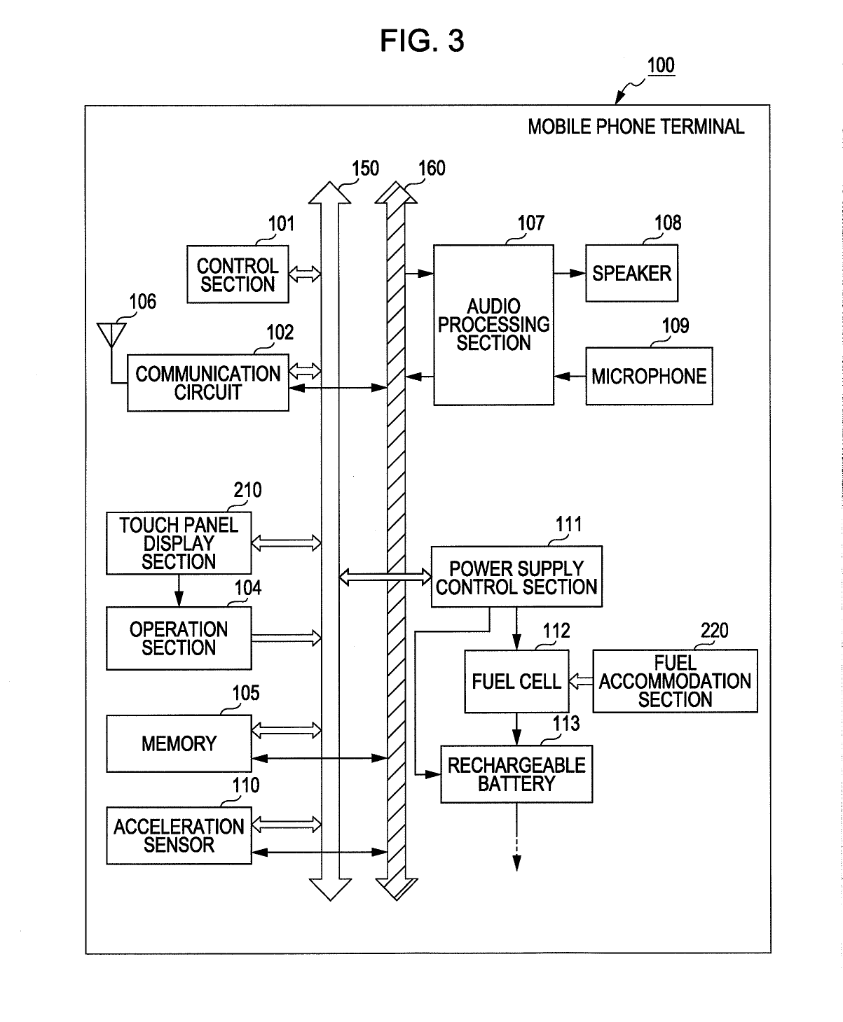

2. Internal configuration of the terminal (FIG. 3)

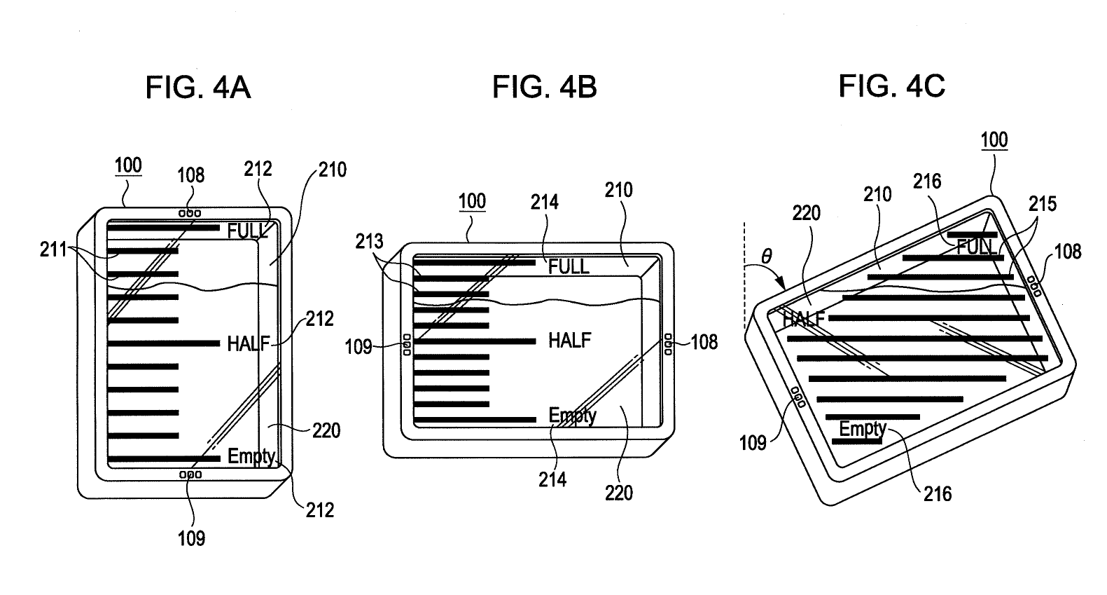

3. Processing to display a volume scale for a fuel cell (FIGS. 4A to 4C)

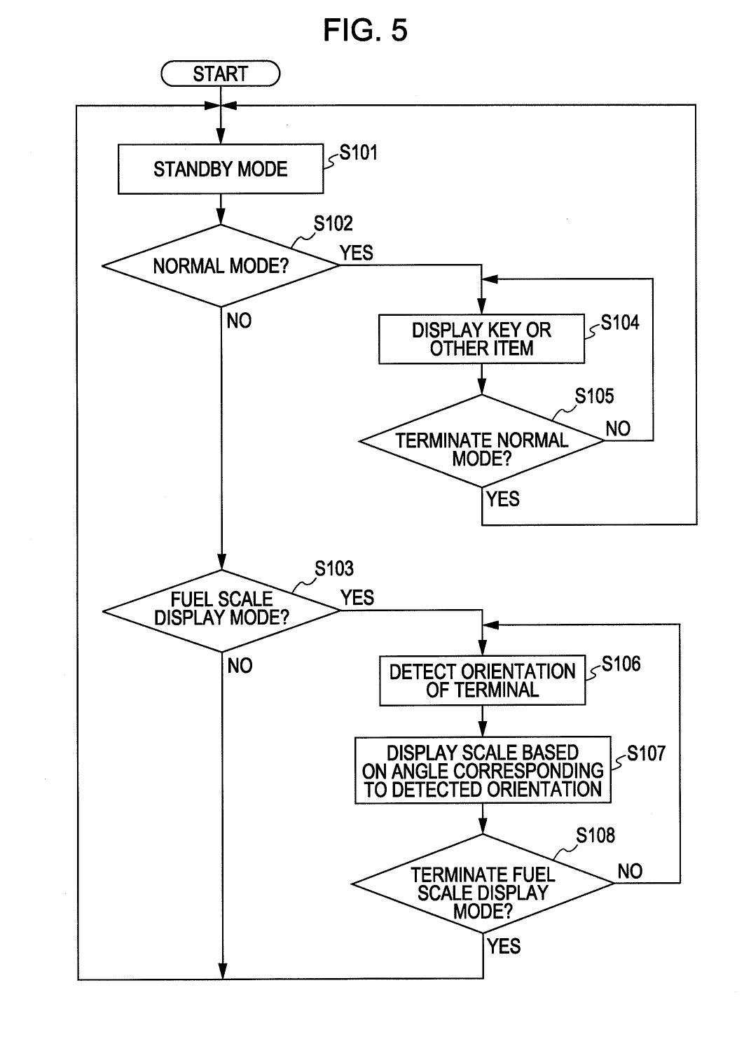

4. Processing to display a scale on a display screen (FIG. 5)

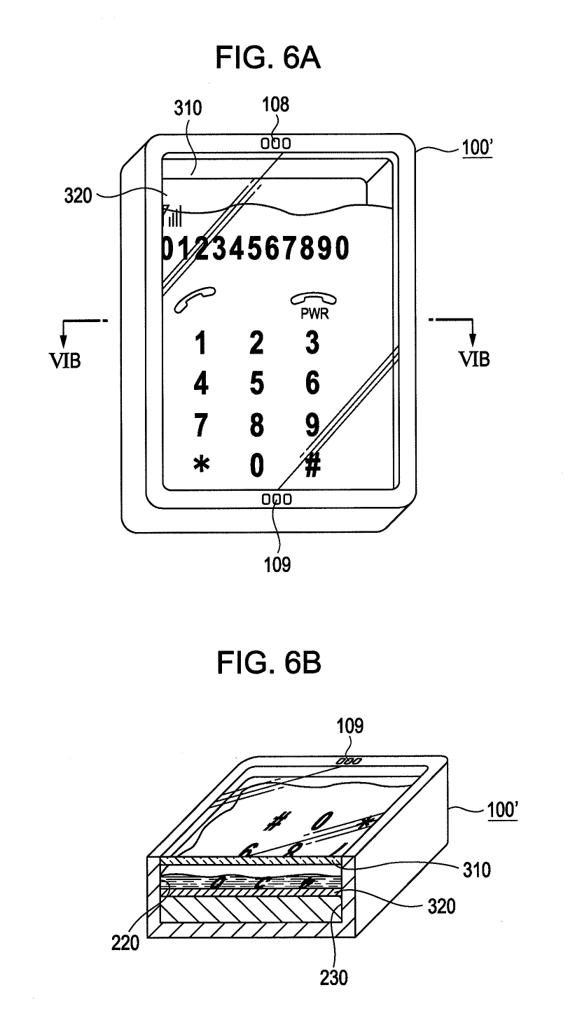

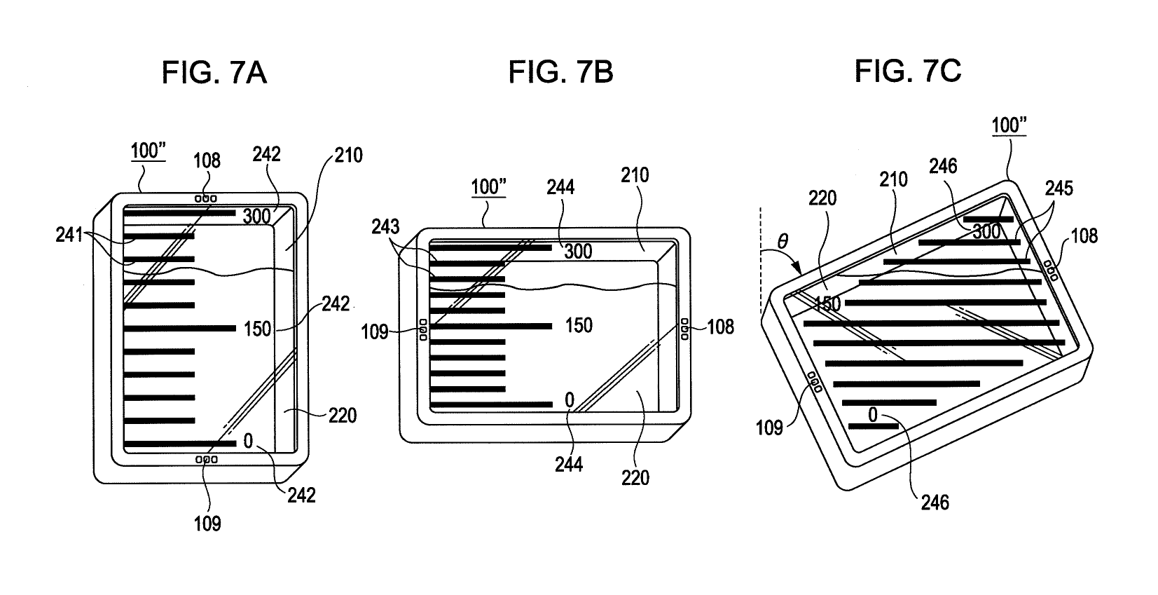

5. Modified example of the embodiment (FIGS. 6A to 7C)

### 1. Outer Shape of a Terminal

Hereinbelow, an embodiment of the present invention will be described with reference to FIGS. 1A and 1B and FIGS. 2A and 2B. This embodiment of the present invention is applied to a mobile phone terminal, which is a mobile terminal device. FIGS. 1A and 1B show an outer shape of the mobile phone terminal, and FIGS. 2A and 2B show a case where a numeric keypad, an input confirmation screen and a signal intensity status icon are displayed on a display section of the mobile phone terminal.

The mobile phone terminal according to this exemplary embodiment is a terminal that has a fuel cell as a power supply. The fuel cell employs a liquid fuel such as methanol, and a fuel accommodation section for storing the fuel is provided within the terminal.

As shown in FIG. 1A, a mobile phone terminal 100 is formed by a rectangular-shaped body. To the whole area of one face, which is a surface of the body, a transparent plate is provided, and a surface of this plate is provided with a touch panel display section 210. The touch panel display section 210 is transparent when displaying is not operated, and, characters, graphics and so on are displayed on the transparent surface thereof. Additionally, the touch panel display section 210 serves as a touch panel in which touching operation can be performed by touching the surface of the touch panel using a finger. Furthermore, a fuel accommodation section 220 for the fuel cell is disposed within the body in a manner that is in contact with the transparent plate provided with the touch panel display section 210. That is, the volume (remaining amount) of the fuel within the fuel accommodation section 220 can be immediately visually recognized through the transparent plate provided with the touch panel display section 210. The fuel accommodation section 220 serving as a fuel tank has a configuration in which the liquid fuel can be externally replenished. Note that the touch panel display section 210 may be formed by a translucent plate tinted to some degree.

Furthermore, as shown in the IB-IB line cross-sectional view in FIG. 1B, under the fuel accommodation section 220, there provided a circuit accommodation section 230 into which a control section for telephone functions or a touch panel and other circuits necessary for the mobile phone terminal to function are integrated. That is, the circuit accommodation section 230 is provided on a face opposite to the face on which the touch panel display section 210 exists. The face of the fuel accommodation section 220 on the side that is in contact with the circuit accommodation section 230 is opaquely formed, so that the inside of the circuit accommodation section 230 is not viewed from the outside.

Note that, as shown in FIGS. 1A and 1B, when nothing is displayed on the touch panel display section 210, this state shows that the mobile phone terminal 100 is not operated by an operator. Additionally, it may be possible to employ a configuration in which the inside of the circuit accommodation section 230 can be viewed from the outside.

To operate the mobile phone terminal 100, in a normal mode, the numeric keypad, the input confirmation screen and the icon indicating the signal intensity status are displayed on the touch panel display section 210 as shown in FIGS. 2A and 2B. By touching and operating the displayed numeric keypad and so on, various operations as a telephone set can be implemented. Furthermore, the terminal according to this embodiment has a fuel scale display mode, which will be described later. Settings of this fuel scale display mode are also made through the operations of the numeric keypad or other items displayed on the touch panel display section 210. When the fuel scale display mode is set, the numeric keypad and other items are not displayed, and a scale for visually recognizing the remaining amount of the fuel is displayed instead.

FIG. 2A shows a case where the numeric keypad, the input confirmation screen and the icon indicating the signal intensity status are displayed on the mobile phone terminal 100. The IIB-IIB line cross-sectional view of FIG. 2B shows a state where the numeric keypad, the input confirmation screen and the icon indicating the signal intensity status are displayed on the touch panel display section 210.

The scale display for visually recognizing the remaining amount of the fuel in the fuel accommodation 220 will be described in <3. Processing to display a volume scale for a fuel cell> below.

Note that touching the touch panel display section 210 or operating a dedicated button (not shown) provided to the mobile phone terminal 100 is a trigger for displaying those items. Additionally, the items displayed are not limited to the numeric keypad, the input confirmation screen and the icon indicating the signal intensity status. The displayed items may be, for example, photos, mails or other items.

A speaker 108 is provided to an upper end portion of the surface of the body provided with the touch panel display section 210, and a microphone 109 is provided to a lower end portion of this surface of the body.

Although these are descriptions of an example in which only one face of the mobile phone terminal 100 is formed by the transparent member, this face is not only a face formed by the transparent member. For example, all of the faces of the mobile phone terminal 100 may be formed by the transparent screen.

### 2. Internal Configuration of the Terminal

Next, with reference to FIG. 3, an example of an internal configuration of the mobile phone terminal 100, which is one exemplary embodiment of the present invention, will be described. The mobile phone terminal 100 has a control section 101 formed by a microprocessor and so on. The control section 101 is connected to each section within the mobile phone terminal 100 through a control line 150 that transmits control signals or a data line 160 that transmits data. Additionally, the control section 101 communicates with each of the sections through these lines, and controls operations of each of the sections.

To the control line 150, a communication circuit 102, the touch panel display section 210, an operation section 104, a memory 105, an audio processing section 107, an acceleration sensor 110 and a power supply control section 111 are connected.

An antenna 106 is connected to the communication circuit 102. The communication circuit 102 demodulates radio waves obtained through the antenna 106, and extracts audio signals or various data transmitted from base stations. Additionally, the audio signals inputted through the data line 160 are supplied to the audio processing section 107. The supplied signals are processed for output, and are then supplied to the speaker 108 to be outputted. Additionally, the microphone 109 is provided for picking up sounds in the vicinity of the terminal, and the picked up sounds are supplied to the audio processing section 107 as analog audio signals. The audio processing section 107 converts the supplied sounds into the audio signals in a prescribed format. The converted audio signals are supplied to the communication circuit 102. Additionally, various kinds of transmitted data other than the audio signals are also supplied to the communication circuit 102. The communication circuit 102 converts the supplied audio signals and other data into radio waves, and outputs them to the antenna 106.

The operation section 104 is formed by dial keys such as numerals, and other various function keys. In the present embodiment, part of the keys of this operation section 104 are formed by the touch panel and keys displayed on the touch panel display section 210 (FIGS. 1A and 1B). Additionally, when a user depresses these keys, operation signals corresponding to the operation contents are generated and supplied to the control section 101.

The touch panel display section 210 includes a display panel formed by a liquid crystal panel and so on, a driving section for the display panel, and the touch panel on the display panel. Additionally, a telephone number of an incoming caller, dial keys such as numerals for the operation section 104 or other various kinds of function keys are displayed. By using this touch panel display section 210, the scale of the battery remaining capacity of the fuel cell, which will be described later, is also displayed.

The memory 105 is a memory section including a ROM (read only memory) and a RAM (random access memory), and stores software necessary for controlling the mobile phone terminal 100 or displaying the volume scale of the fuel-cell fuel, and so on. Additionally, the memory 105 stores data temporarily generated when the control section 101 performs control, or other data. Note that scale information described below is also stored in the memory 105. As for this scale information, in this embodiment, plural types of scale information concerning different orientations are stored. As the plural types of scale information, for example, 10 types of scale information are prepared and stored in 10-degree steps from scale information in a state where the body is in an upright position to scale information in a state where the body is in a horizontal position. Alternatively, it may be possible to prepare and store the scale information in 10-degree steps in all directions of 360 degrees. Preparation in 10-degree steps is just one example, and it may be possible to divide the steps in more fined steps or in more rough steps. Specific example of scales in plural orientations will be described later.

The power supply control section 111 controls a fuel cell 112 and a rechargeable battery 113. The fuel cell 112 generates electricity by consuming a supplied fuel. Then, the power supply obtained through the electricity generation is supplied to the rechargeable battery 113 and is recharged. Furthermore, the power supply from this rechargeable battery 113 is supplied as the necessary power supply to each section within the mobile phone terminal 100, and drives each circuit. The fuel cell 112 generates electricity by using the fuel supplied from the fuel accommodation section 220 through a fuel pump.

Note that, as the fuel supplied to the fuel cell 112 (that is, the fuel accommodated in the fuel accommodation section 220), it may be possible to employ, for example, methanol, aqueous methanol solution, liquid hydrogen or other appropriate liquid or liquefied material containing hydrogen component.

The acceleration sensor 110 detects orientations of the body of the mobile phone terminal 100. That is to say, the acceleration sensor 110 is provided as a body orientation detection section that can detect whether the body of the terminal is in an upright position or the body is in a horizontal position or the body is in a tilted position. The detected orientation information is supplied to the control section 101. Note that the orientation of the terminal may be detected by using a sensor other than the acceleration sensor 110.

In a state where the display mode is set to the fuel scale display mode, the control section 101 reads the scale information concerning the appropriate display orientation from the memory 105 on the basis of the orientation information detected by the acceleration sensor 110. Then, the scale according to the read scale information is displayed. In this embodiment, the scale information associated with the angle closest to an angle of the detected body orientation is read from the memory 105, and the scale is displayed.

### 3. Processing to Display a Volume Scale for a Fuel-Cell Fuel

Next, according to the mobile phone terminal 100 of the exemplary embodiment of the present invention, description will be made of processing to display the scale on the touch panel display section 210 to visually recognize the remaining amount of the fuel, with reference to FIGS. 4A to 4C.

This displaying processing is implemented under the fuel scale display mode, and is implemented such that the orientation of the scale displayed on the touch panel display section 210 varies depending on the orientation of the body of the mobile phone terminal 100 detected by the acceleration sensor 110. Note that touching the touch panel display section 210 or depressing a dedicated button provided to the mobile phone terminal 100 is a trigger for displaying the scale as this fuel display mode.

With reference to FIG. 4A, description will be made of an example of the scale display in a case where, as a result of detection by the acceleration sensor 110, the upper end of the body of the mobile phone terminal 100 directs upward. In this case, on the touch panel display section 210, a scale 211 is displayed at boundaries dividing the screen of the touch panel display section 210 into 10 parts in the vertical direction, and at upper and lower ends of the screen. Additionally, a scale position display 212 is displayed such that there displayed a wording “FULL” at the side of the scale marking existing at the highest position in the vertical direction, a wording “Empty” at the side of the scale marking existing at the lowest position in the vertical direction, and a wording “HALF” at the side of the scale marking existing at the halfway point. In a state shown in FIG. 4A, it can be visually recognized that the remaining amount of the fuel in the fuel accommodation section 220 is approximately 70%, on the basis of the displayed scale 211.

With reference to FIG. 4B, description will be made of a case where, as a result of detection by the acceleration sensor 110, the upper end of the body of the mobile phone terminal 100 is turned 90 degrees clockwise from the upright position. In this case, on the touch panel display section 210, a scale 213 is displayed at the boundaries dividing the screen of the touch panel display section 210 into 10 parts in the vertical direction, and at the upper and lower ends of the screen. Additionally, a scale position display 214 is displayed such that there displayed a wording “FULL” at the side of the scale marking existing at the highest position in the vertical direction, a wording “Empty” at the side of the scale marking existing at the lowest position in the vertical direction, and a wording “HALF” at the side of the scale marking existing at the halfway point. In a state shown in FIG. 4B, it can be visually recognized that the remaining amount of the fuel in the fuel accommodation section 220 is approximately 70%, on the basis of the displayed scale 213.

With reference to FIG. 4C, description will be made of a case where, as a result of detection by the acceleration sensor 110, the upper end of the body of the mobile phone terminal 100 is tilted θ degrees (here, θ is approximately 60 degrees) clockwise from the upright position. In this case, on the touch panel display section 210, a scale 215 is displayed at the boundaries dividing the screen of the touch panel display section 210 into 10 parts in the vertical direction, and at the upper and lower ends of the screen. Additionally, a scale position display 216 is displayed such that there displayed a wording “FULL” under the scale marking existing at the highest position in the vertical direction, a wording “Empty” above the scale marking existing at the lowest position in the vertical direction, and a wording “HALF” above the scale marking existing at the halfway point. In a state shown in FIG. 4C, it can be visually recognized that the remaining amount of the fuel in the fuel accommodation section 220 is approximately 70%, on the basis of the displayed scale 215.

As described above, with this embodiment, on the basis of the information detected by the acceleration sensor 110, the scale parallel to the horizontal surface of the fuel is displayed even in a case where the terminal is in any orientations.

Incidentally, in the example shown in FIGS. 4A to 4C, the scale has 10 scale markings. However, if possible, more than 10 scale markings may be displayed to confirm the remaining amount of the fuel in the fuel accommodation section 220 in more detail. Alternatively, the scale display may have rougher scale than that of the example shown in FIGS. 4A to 4C. Additionally, regarding the scale displayed at the time when the terminal is tilted as show in FIG. 4C, it may be possible to employ the scale markings obtained by correctly dividing the volume of the fuel accommodation section 220, rather than employing the scale markings obtained by dividing the distance in equal intervals.

### 4. Processing to Display a Scale on a Display Screen

Next, with reference to a flowchart in FIG. 5, description will be made of an example of processing to display the scale on the touch panel display section 210 of the mobile phone terminal 100 in accordance with the angle detected by the acceleration sensor 110.

In the flowchart shown in FIG. 5, the mobile phone terminal 100 is first in a state (standby mode) where nothing is displayed on the touch panel display section 210, as shown in FIGS. 1A and 1B (step S101).

Upon touching the touch panel display section 210 or depressing the dedicated button provided to the mobile phone terminal 100, determination is made whether the mode is shifted to a normal mode (step S102). Note that the normal mode is a mode in which a telephone number of an incoming caller, dial keys such as numerals or other various kinds of function keys are displayed on the touch panel display section 210 as shown in FIGS. 2A and 2B.

When the mode is shifted to the normal mode, the telephone number of the incoming caller, dial keys such as numerals or other various kinds of function keys are displayed on the touch panel display section 210 (step S104). Then, by using the dial keys or other various function keys, making a call or other operation is performed. Upon completion of the operation, determination is made whether the normal mode is terminated (step S105). When the normal mode is not terminated, various keys are displayed so that further operation can be performed. When the normal mode is terminated, the mode is shifted to the standby mode (step S101).

When the mode is not shifted to the normal mode, determination is made whether the mode is shifted to the fuel scale display mode (step S103). When the mode is not shifted to the fuel scale display mode, the mode is shifted to the standby mode (step S101).

On the other hand, when the mode is shifted to the fuel scale display mode, the acceleration sensor 110 first detects the orientation of the mobile phone terminal 100 (step S106). Then, the scale corresponding to the detected orientation is displayed on the touch panel display section 210 (step S107).

Next, determination is made whether the fuel scale display mode is terminated (step S108). When the fuel scale display mode is not terminated, the process returns to step S106 to display the scale. When the fuel scale display mode is terminated, the mode is shifted to the standby mode (step S101).

As described above, according to the present embodiment, the fuel cell 112 can be visually recognized through the transparent plate having the touch panel display section 210, and the remaining amount of the fuel can be easily confirmed by displaying the scale on the touch panel display section 210. Additionally, regardless of the orientation of the body of the mobile phone terminal 100, the scale is horizontally displayed. Therefore, the remaining amount of the fuel can be easily confirmed.

### 5. Modified Example of the Embodiment

In the embodiment described above, an example where the embodiment of the present invention is applied to the mobile phone terminal has been described. However, this embodiment may be applied to a fuel-cell-driven mobile terminal device other than the mobile phone terminal. For example, it may be possible to form the keypad or display of a portable audio play device in a transparent form, and provide the fuel cell therewithin. Additionally, in a case of the so-called clamshell-type mobile phone terminal in which two bodies are joined in a manner that can be freely opened and closed, as a housing for the fuel cell, it may be possible to employ a housing in which a body on the side of the display or keypad, or both of the bodies are formed by a transparent member. That is, it is only necessary to switch the screen from the keypad or display to the scale.

The above-described embodiment has a configuration in which the touch panel display section 210 is provided to the transparent plate attached on the whole of one face of the body of the mobile phone terminal 100. Alternatively, it may be possible to employ a configuration in which a display section that displays a scale is provided at a bottom portion of the fuel accommodation section.

FIGS. 6A and 6B show a configuration example of this case. In this mobile phone terminal 100′, the fuel accommodation section 220 is provided within the body, and the surface side of the body is made transparent or translucent. Additionally, as shown in a sectional view in FIG. 6B, a touch panel 310 is provided on the surface side of the fuel accommodation section 220, and a display section 320 is provided on the bottom side of the fuel accommodation section 220. The display side of the display section 320 is faced toward the fuel accommodation section 220. Accordingly, the display section 320 can be viewed from the outside through the fuel accommodation section 220. Additionally, when the fuel display mode is set, the scale is displayed on this display section 320. An example of displaying the scale is similar to the displaying example shown in FIGS. 4A to 4C.

With the configuration shown in FIGS. 6A and 6B as well, a similar effect to the example shown in FIGS. 1A and 1B can be obtained.

The scale of the above-described embodiment is formed so as to easily visually recognize the remaining amount of the fuel. Alternatively, the scale may be formed so as to display the remaining time such as how much time the fuel cell can supply the electric power for telephone conversation or standby state.

As one example, with reference to FIGS. 7A to 7C, description will be made of processing to display the scale to the touch panel display section 210 on a time basis to recognize the remaining conversation time of the fuel cell in the mobile phone terminal 100″.

Similar to the display processing described in <4. Processing to display a scale on a display screen>, this display processing is implemented under the fuel scale display mode, and implemented such that the orientation of the scale displayed on the touch panel display section 210 varies depending on the orientation of the body of the mobile phone terminal 100 detected by the acceleration sensor 110. However, this scale display is made on the time basis. Note that, in this example, the available conversation time when the fuel is filled at maximum is 300 minutes.

With reference to FIG. 7A, description will be made of an example of the scale display in a case where, as a result of detection by the acceleration sensor 110, the upper end of the body of the mobile phone terminal 100″ directs upward. In this case, on the touch panel display section 210, a scale 241 is displayed at boundaries dividing the screen of the touch panel display section 210 into 10 parts in the vertical direction, and at upper and lower ends of the screen. Additionally, a scale position display 242 is displayed such that there displayed a numeral “300” at the side of the scale marking existing at the highest position in the vertical direction, a numeral “0” at the side of the scale marking existing at the lowest position in the vertical direction, and a numeral “150” at the side of the scale marking existing at the halfway point. In a state shown in FIG. 7A, it can be visually recognized that the remaining amount of the fuel in the fuel accommodation section 220 corresponds to approximately 210 minutes for telephone conversation, on the basis of the displayed scale 241.

With reference to FIG. 7B, description will be made of a case where, as a result of detection by the acceleration sensor 110, the upper end of the body of the mobile phone terminal 100″ is turned 90 degrees clockwise from the upright position. In this case, on the touch panel display section 210, a scale 243 is displayed at the boundaries dividing the screen of the touch panel display section 210 into 10 parts in the vertical direction, and at the upper and lower ends of the screen. Additionally, a scale position display 244 is displayed such that there displayed a numeral “300” at the side of the scale marking existing at the highest position in the vertical direction, a numeral “0” at the side of the scale marking existing at the lowest position in the vertical direction, and a numeral “150” at the side of the scale marking existing at the halfway point. In a state shown in FIG. 7B, it can be visually recognized that the remaining amount of the fuel in the fuel accommodation section 220 corresponds to approximately 210 minutes for telephone conversation, on the basis of the displayed scale 243.

With reference to FIG. 7C, description will be made of a case where, as a result of detection by the acceleration sensor 110, the upper end of the body of the mobile phone terminal 100″ is tilted θ degrees (here, θ is approximately 60 degrees) clockwise from the upright position. In this case, on the touch panel display section 210, a scale 245 is displayed at the boundaries dividing the screen of the touch panel display section 210 into 10 parts in the vertical direction and at the upper and lower ends of the screen. Additionally, a scale position display 246 is displayed such that there displayed a numeral “300” under the scale marking existing at the highest position in the vertical direction, a numeral “0” above the scale marking existing at the lowest position in the vertical direction, and a numeral “150” above the scale marking existing at the halfway point. In a state shown in FIG. 7C, it can be visually recognized that the remaining amount of the fuel in the fuel accommodation section 220 corresponds to approximately 210 minutes for telephone conversation, on the basis of the displayed scale 245.

As described above, with this embodiment, on the basis of the information detected by the acceleration sensor 110, the scale parallel to the horizontal surface of the fuel is displayed even in a case where the terminal is in any orientations.

With the configuration shown in FIGS. 7A to 7C as well, a similar effect to the example shown in FIGS. 1A and 1B can be obtained.

The scale for the available telephone conversation time is displayed upon touching the touch panel display section 210 or operating a not-shown dedicated button provided to the mobile phone terminal 100. However, in addition to the telephone conversation duration, it may be possible to sequentially display the remaining time of a videophone conversation time, standby time, television watching time, etc. by further operating this trigger.

On the touch panel display section 210, only one time-scale is displayed. However, two or more time-scales may be displayed. For example, to simultaneously display the telephone conversation time and the standby time, scales may be separately arranged such that the scale for easily visually recognizing the remaining time for telephone conversation is displayed on the left side of the display screen while the scale for easily visually recognizing the remaining standby time is displayed on the right side of the display screen.

The mobile phone terminal 100 may be provided with an illuminating unit that illuminates the inside of the fuel accommodation section 220. With this illuminating unit, the remaining amount of the fuel can be recognized even in a dark place. Furthermore, it may be possible to further enhance the visibility by mixing a color or reflective material into the fuel itself. A beautiful illumination effect can be obtained by illuminating light in addition to mixing of the color or reflective material.

Bubbles may be contained in the fuel accommodation section 220. Furthermore, in lieu of the bubbles, a float may be provided within the fuel accommodation section 220 so that the movement of the float can be detected.

A measuring device for measuring the remaining amount of the fuel contained in the fuel accommodation section 220 may be provided. On the basis of the remaining amount of the fuel, the available remaining time for telephone conversation by the mobile phone terminal 100 may be calculated.

The present application contains subject matter related to that disclosed in Japanese Priority Patent Application JP 2009-132486 filed in the Japan Patent Office on Jun. 1, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A mobile terminal, comprising:
a fuel accommodation section that accommodates a fuel within a body, at least one face of the fuel accommodation section being formed by a transparent or translucent member;
a fuel cell section that generates electricity on the basis of the fuel accommodated in the fuel accommodation section;
a body orientation detection section that detects an orientation of the body;
a storage section that stores scale display information concerning a plurality of orientations of the fuel accommodation section;
a display section disposed on the face of the fuel accommodation section formed by the transparent or translucent member; and
a control section that obtains the scale display information corresponding to the orientation detected by the body orientation detection section from the scale display information stored in the storage section, and displays the obtained scale display information on the display section.

2. The mobile terminal according to claim 1, wherein a scale that the control section causes the display section to display is a scale displayed with a line substantially parallel to a horizontal surface of the fuel in the fuel accommodation section.

3. The mobile terminal according to claim 1, wherein the control section causes the display section to display the scale on the basis of a predetermined operation.

4. The mobile terminal according to claim 1, further comprising an illumination section that illuminates the fuel accommodation section.

5. The mobile terminal according to claim 1, further comprising a remaining amount detection section that detects a remaining amount of the fuel accommodated in the fuel accommodation section, wherein the control section causes the display section to display the remaining amount detected by the remaining amount detection section.

6. A method for confirming a remaining capacity of a fuel cell, comprising the steps of:
detecting an orientation of a body that forms a terminal;
storing scale display information concerning a plurality of orientations;
obtaining the scale display information corresponding to the detected orientation from the stored scale display information; and
displaying a scale based on the obtained scale display information on a transparent or translucent face which is one of faces of a housing of a fuel accommodation section that accommodates the fuel.
